(19) United States
(12) Patent Application Publication
(10) Pub. No.: US 2026/0041524 A1
(43) Pub. Date: Feb. 12, 2026

(54) SOCKET SHIELD TECHNIQUE KIT

(71) Applicant: Hasib Aldary, Amman (JO)

(72) Inventor: Hasib Aldary, Amman (JO)

(73) Assignee: Hasib Aldary, Amman (JO)

(21) Appl. No.: 19/104,237

(22) PCT Filed: Aug. 17, 2022
(86) PCT No.: PCT/JO2022/050015

§ 371 Date: Feb. 17, 2025

(51) Int. Cl. A61C 5/44; A61C 5/42

(52) U.S. Cl. CPC A61C 5/44; A61C 5/42

(57) ABSTRACT

There is provided a kit for performing socket shield technique, and methods for using the kit, wherein the kit may include a wheel bur, having a first working surface disc and a second working surface disc configured to smoothen and cut hard tissues of a tooth; one or more trephine burs with stoppers configured to cut a root canal to create a first tooth fragment and a second tooth fragment, wherein each stopper is compatible with each of the one or more trephine burs; a root fragment remover configured to extract the first tooth fragment and stabilize the second tooth fragment; a split end elevator having a v-shaped notch tip configured to remove the first tooth fragment; a cylindrical bur to control the thickness of the second root fragment; and a round bur configured to separate the second root fragment from unwanted fragments.

### TECHNICAL FIELD

The present disclosure relates to dental implant instruments, and more particularly to a kit that would enable a dentist to perform socket shield technique easily and precisely.

### BACKGROUND

The Socket shield technique was first introduced by Hurzeler to avoid tissue alterations of the ridge after tooth extraction, and it is used in implant dentistry as a way of socket preservation before implant placement. It aims to perform the optimal aesthetic results of the future prosthesis which is retained by the implant.

Dental implants, systems, and kits are widely disclosed in the prior art. For instance, the international patent application publication number WO2001012098 discloses a kit system comprising a plurality of disposable kits and a method of using the kits, each kit being adapted for post-extraction dental implantation on a particular dental area. Each kit includes a dental implant of specified dimensions for a particular dental area of the mouth, a transfer coping attachable to the dental implant for creating an impression for making a model to produce a prosthetic tooth, bone graft material for filling the void area around a portion of the implant after implantation, burrs and bone expanders, and a portable housing for storing the dental implant, the transfer coping, the bone graft material, wound dressing, burrs and bone expanders.

The international application published under number WO2016163579, discloses a dental implant kit comprising a drill set including a plurality of linear drill units, each of which has a cutting part, of which a portion for cutting is provided in a linear shape, and a guide part coupled with the cutting part, and forming an implantation hole in the alveolar bone for the implantation of a fixture; and a guide stent having a guide hole for guiding the linear drill units, wherein each of the plurality of linear drill units has the guide part, which has the same diameter as the other guide parts, and the guide hole formed in the guide stent has a diameter corresponding to that of the guide part so as to guide the guide part.

The Chinese patent application publication number CN109498185, discloses a shield technique guide structure, a guide plate and a socket shield technique operation method. The shield technique guide structure comprises a locating piece and at least one guide rail, wherein the at least one guide rail is used to keep a relative position with a tooth root to be shielded; the at least one guide rail defines a predetermined rail; the predetermined rail extends along the preparative contour of the tooth root to be shielded; the locating piece is movably matched with the at least one guide rail; the locating piece is used to do reciprocating motion along the predetermined rail; the locating piece comprises a locating part; the locating part is matched with a turning mechanism to keep the relative position between the locating piece and the turning mechanism. The turning mechanism moves with the locating piece along the predetermined rail.

A study titled “The Socket Shield Technique using Bone Trephine: A Case Report” published by the inventor himself in year 2015 discloses a socket shield technique performed using bone trephine to take out the remaining root on a tooth leaving an organized rounded section of the palatal/lingual extraction site with a semi lunar internal shape of the buccal aspect of the root that will receive an implant, wherein after delivering the implant prosthesis, an unchanged emergence profile was noted.

The socket shield technique comprises a set of instruments that should be used in a certain order and high level of accuracy to be performed correctly. It is a sensitive procedure and must be performed by experienced practitioners.

### SUMMARY

Therefore, it is an object of the present disclosure to provide a socket shield kit that enables less experienced practitioners to perform the socket shield technique in an easier and more predictable way.

Aspects of the present disclosure provide a kit for performing socket shield technique that may include a wheel bur, having a first working surface disc and a second working surface disc that may be configured to smoothen and cut hard tissues of a tooth; one or more trephine burs with stoppers may be configured to cut a root canal to create a first tooth fragment and a second tooth fragment, wherein each stopper may be compatible with each of the one or more trephine burs; a root-fragment remover that may be configured to extract the first tooth fragment and stabilize the second tooth fragment; a split end elevator having a v-shaped notch tip configured to remove the first tooth fragment; a cylindrical bur to control the thickness of the second root fragment; and a round bur may be configured to separate the second root fragment from unwanted fragments.

In some aspects of the present disclosure, the kit may further comprise a first drill and a second drill.

In some aspects, the kit may further comprise a diameter gauge.

In some aspects, the kit may further comprise one or more sleeves to be installed in a computer designed surgical guide template that may be configured to guide the one or more trephine burs.

In some aspects, the first drill and the second drill may have a first rotating drill bit and a second rotating drill bit that may be configured to create a hole in the root canal when rotating.

In some aspects, the first drill and the second drill may be configured to widen the root canal to receive the diameter gauge.

In some aspects, the first drill and the second drill may have different sizes.

In some aspects, the first drill and the second drill may have calibration marks to indicate the depth of the drilling.

In some aspects, the first working surface disc of the wheel bur may be a coarse surface working disc.

In some aspects, the second working surface disc of the wheel bur may be a fine surface working disc.

In some aspects of the disclosure, the first coarse working surface disc of the wheel bur may be configured to cut hard tissues of a tooth.

In other aspects of the disclosure, the second fine working surface disc of the wheel bur may be configured to smoothen the surface of the tooth.

In some aspects, the wheel bur may be compatible with a slow speed and high-speed hand piece.

In some aspects, the diameter gauge may be a round disc with a vertical bar positioned in the center of the round disc.

In some aspects, the one or more trephine burs may have different sizes.

In some aspects of the disclosure, the diameter gauge may be configured to identify the dimensions of the root canal.

In some aspects, the diameter gauge may be configured to determine the size of the one or more trephine burs to cut the remaining root.

In some aspects, the one or trephine burs may be configured to receive the diameter gauge to guide cutting the root canal.

In some aspects, the diameter gauge may be configured to be incorporated within the one or more trephine burs to stabilize the path of cutting the root canal, thus preventing the one or more trephine burs from deviation while cutting.

In some aspects, trephining the root by the one or more trephine burs may create the first tooth fragment and the second tooth fragment on each side of the root.

In some aspects, the one or more trephine burs may have calibration marks to indicate a reached depth while trephining the root.

In some aspects, the stoppers may be configured to prevent the one or more trephine burs from slipping on an occlusal surface of the root while trephining.

In other aspects of the disclosure, the one or more sleeves may be configured to be incorporated within the computer designed surgical guide template and may be compatible with each of the one or more trephine burs size.

In some aspects of the disclosure, the one or more sleeves may be made of metal.

In some aspects, the one or more sleeves may have a ring shape.

In some aspects, the one or more trephine burs may be positioned inside the sleeves to guide the trajectory of trephining.

In aspects of the disclosure, the root fragment remover may be a cylindrical hollow housing having an upper end, a lower end, a wall, a first lateral cut, and a second lateral cut.

In some aspects, the wall may have a portion between the first lateral cut and the second lateral cut, wherein the portion may act as a gripper.

In some aspects, the portion may move relatively to the wall when a lateral force applied thereon, thus enabling the extraction of the first tooth fragment.

In some aspects, the v-shaped notch tip of the split end elevator may enable removing the first root fragment without causing any damage to the alveolar bone.

In some aspects, the v-shaped notch tip of the split end elevator removes the first root fragment by a twist move.

In some aspects, removing the first root fragment may be done by positioning the first root fragment in-between the split end elevator's v-shaped notch tip.

In some aspects, the cylindrical bur may have a shank and a rotating head.

In some aspects, the cylindrical bur may control the thickness of the second tooth fragment.

In some aspects, the round bur may have a shank and a rotating head.

In some aspects, the round bur may be configured to have a built-in stopper.

In some aspects, the round bur may separate unwanted fragments from the second tooth fragment.

### BRIEF DESCRIPTION OF THE DRAWINGS

The disclosure will now be described with reference to the accompanying drawings, without however limiting the scope of the disclosure thereto, and in which:

FIG. 1A illustrates a front view of a wheel bur with the first working surface disc in a socket shield technique kit configured in accordance with embodiments of the present disclosure.

FIG. 1B illustrates a schematic diagram showing an application of the wheel bur's first working surface disc at an exemplary site requiring a socket shield technique implant, wherein the socket shield technique is being performed using the socket shield kit configured in accordance with embodiments of the present disclosure.

FIG. 2A illustrates a front view wheel bur with the second working surface disc in a socket shield technique kit configured in accordance with embodiments of the present disclosure.

FIG. 2B illustrates a schematic diagram showing an application of the wheel bur's second working surface disc at an exemplary site requiring a socket shield technique implant, wherein the socket shield technique is being performed using the socket shield kit configured in accordance with embodiments of the present disclosure.

FIG. 3A illustrates a front view of first drill in a socket shield technique kit configured in accordance with embodiments of the present disclosure.

FIG. 3B illustrates a schematic diagram showing an application of the first drill at an exemplary site requiring a socket shield technique implant, wherein the socket shield technique is being performed using the socket shield kit configured in accordance with embodiments of the present disclosure.

FIG. 4A illustrates a front view of a second drill in a socket shield technique kit configured in accordance with embodiments of the present disclosure.

FIG. 4B illustrates a schematic diagram showing an application of the second drill at an exemplary site requiring a socket-shield technique implant, wherein the socket shield technique is being performed using the socket shield technique kit configured in accordance with embodiments of the present disclosure.

FIG. 5A illustrates a front view of a diameter gauge in a socket shield technique kit configured in accordance with embodiments of the present disclosure.

FIG. 5B illustrates a schematic diagram showing an application of the diameter gauge at an exemplary site of a tooth requiring socket shield technique implant, wherein the socket shield technique is being performed using the socket shield technique kit configured in accordance with embodiments of the present disclosure.

FIG. 6A illustrates a perspective view of a trephine bur with a stopper in a socket shield technique kit configured in accordance with embodiments of the present disclosure.

FIG. 6B illustrates a schematic diagram showing an application of the trephine bur with a stopper at an exemplary site requiring a socket shield technique implant, wherein the socket shield technique is being performed using the socket shield technique kit configured in accordance with embodiments of the present disclosure.

FIG. 6C illustrates a schematic diagram showing a tooth root after application of the trephine bur with a stopper at an exemplary site requiring a socket shield technique implant, wherein the socket shield technique is being performed using the socket shield technique kit configured in accordance with embodiments of the present disclosure.

FIG. 7A illustrates a perspective view of a root-fragment remover in a socket shield technique kit configured in accordance with embodiments of the present disclosure.

FIG. 7B illustrates a schematic diagram showing an application of the root-fragment remover at an exemplary site of a tooth requiring socket shield technique implant, wherein the socket shield technique is being performed using the socket shield technique kit configured in accordance with embodiments of the present disclosure.

FIG. 8A illustrates a front view of a split-end elevator in a socket shield technique kit configured in accordance with embodiments of the present disclosure.

FIG. 8B illustrates a schematic diagram showing an application of the split-end elevator at an exemplary site requiring a socket shield technique implant, wherein the socket shield technique is being performed using the socket shield technique kit configured in accordance with embodiments of the present disclosure.

FIG. 9A illustrates a front view of a cylindrical bur in a socket shield technique kit configured in accordance with embodiments of the present disclosure.

FIG. 9B illustrates a schematic diagram showing an application of the cylindrical bur at an exemplary site requiring a socket shield technique implant, wherein the socket shield technique is being performed using the socket shield technique kit configured in accordance with embodiments of the present disclosure.

FIG. 10A illustrates a front view of a round bur in a socket shield technique kit configured in accordance with embodiments of the present disclosure.

FIG. 10B illustrates a schematic diagram showing an application of the round bur at an exemplary site requiring a socket shield technique implant, wherein the socket shield technique is being performed using the socket shield technique kit configured in accordance with embodiments of the present disclosure.

FIG. 11 illustrates a perspective view of a sleeve in a socket shield technique kit configured in accordance with embodiments of the present disclosure.

FIG. 12 illustrates a perspective view of a sleeve incorporated with a computer designed surgical guide template in a socket shield technique kit configured in accordance with embodiments of the present disclosure.

FIG. 13 illustrates a flow chart of a method for performing socket shield technique using the socket shield technique kit of the present disclosure, wherein the method is configured in accordance with some embodiments of the present disclosure.

FIG. 14 illustrates a flow chart for a method of performing socket shield technique using the socket shield technique kit configured in accordance with other embodiments of the present disclosure.

### DETAILED DESCRIPTION

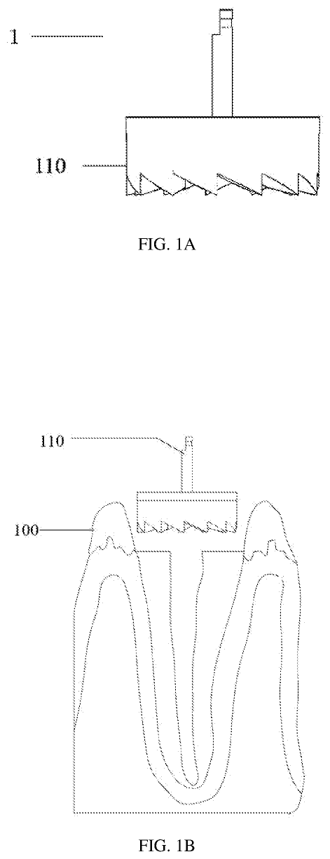

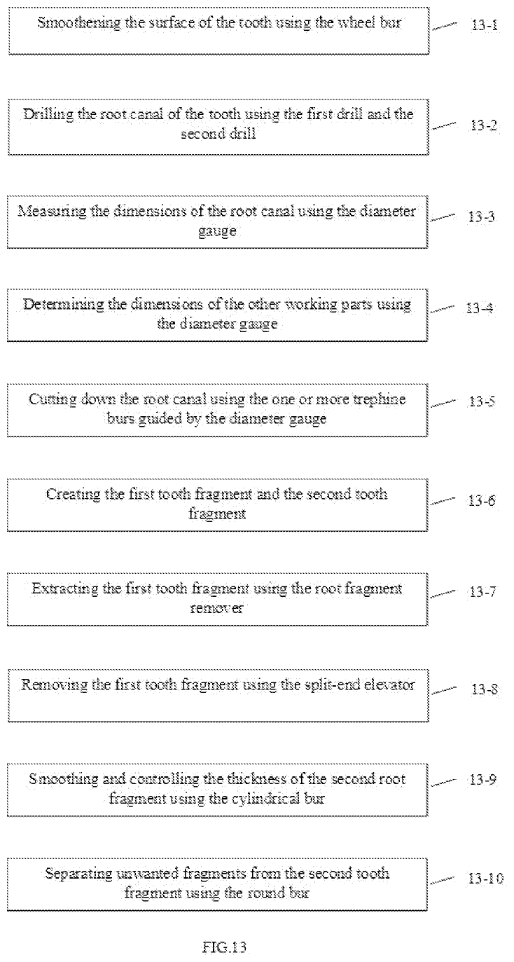

FIGS. 1A-10B illustrate a kit for performing a socket shield technique configured in accordance with embodiments of the present disclosure, wherein such kit enables less experienced practitioners to perform socket shield technique in an easier and more predictable way.
i. FIG. 13 illustrates a flow chart for a method for performing socket shield technique using the kit configured according to embodiments of the present disclosure.

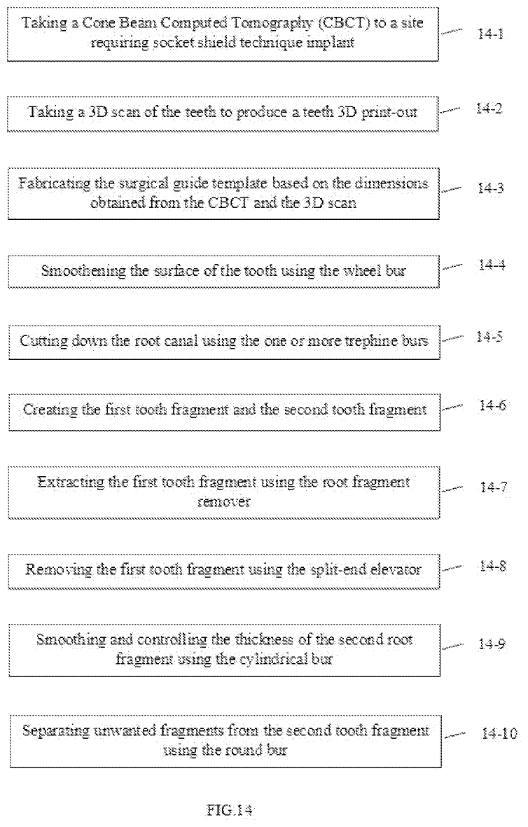

FIG. 14 illustrates a flow chart for a method for performing socket shield technique using the kit configured according to other embodiments of the present disclosure.

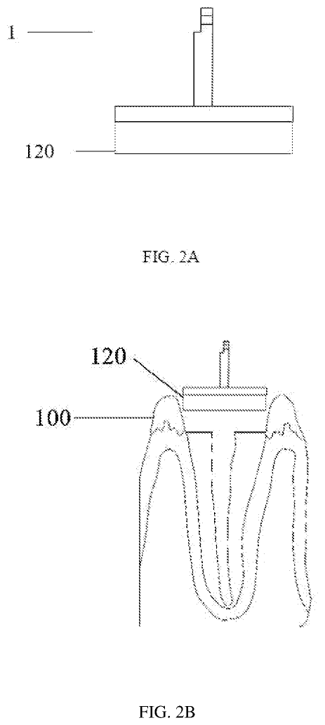

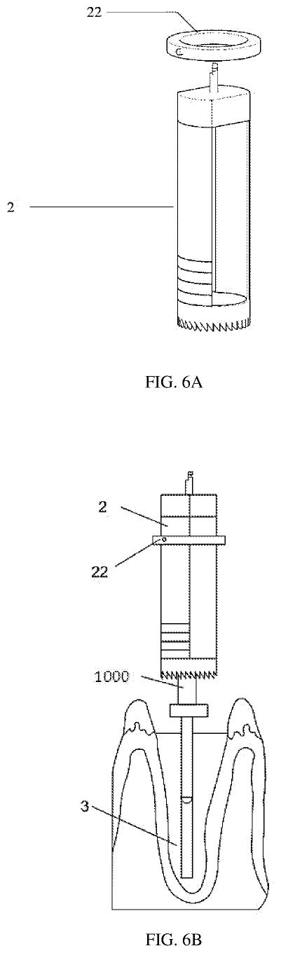

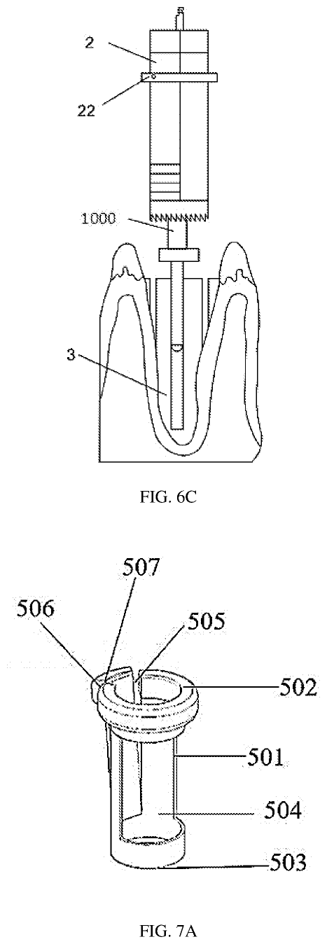

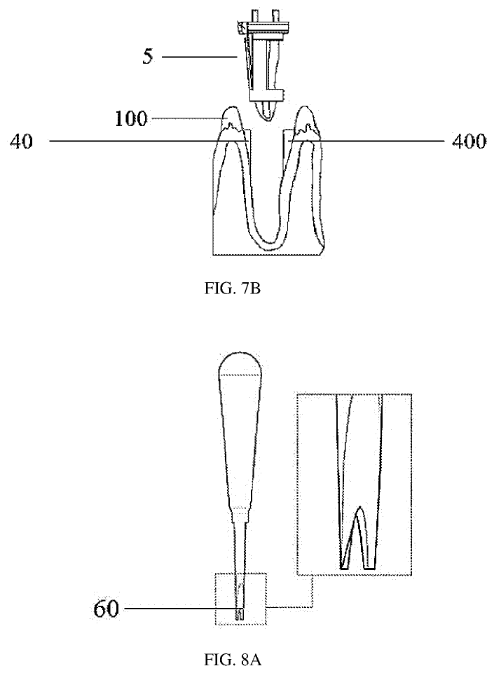

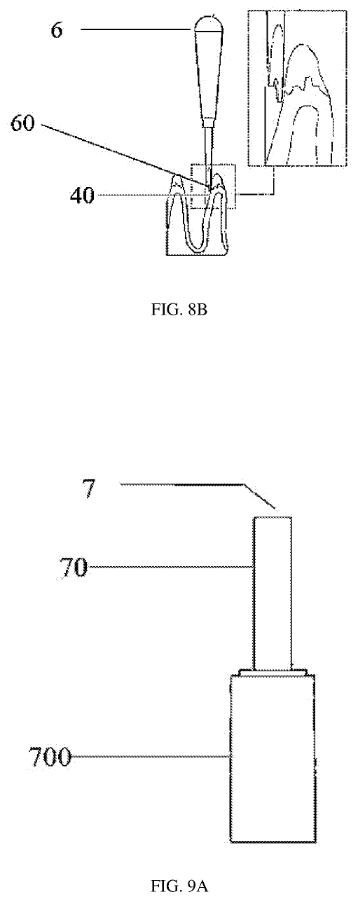

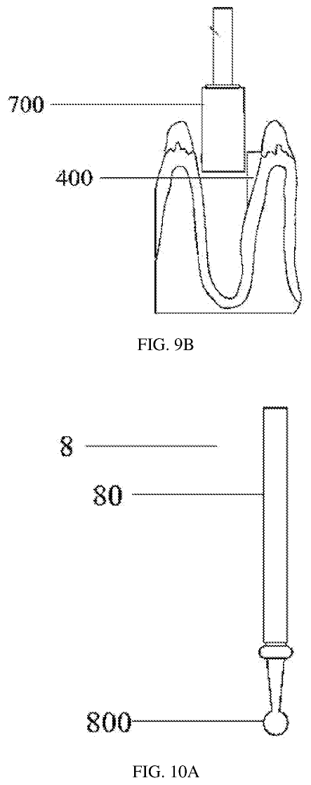

In one embodiment of the present disclosure, the kit may include a wheel bur 1, having a first working surface disc 110 and a second working surface disc 120, wherein the first working surface disc may be configured to cut hard tissues of a tooth and wherein the second working surface disc may be configured to smoothen a surface of the tooth 100 (FIGS. 1A-2B); one or more trephine burs 2 with stoppers 22 (FIGS. 6A-6C), the one or more trephine burs 2 may be configured to cut a root canal 3 of a tooth 100 to create a first tooth fragment 40 and a second tooth fragment 400 (FIGS. 7A, 7B), wherein each stopper 22 may be compatible with each of the one or more trephine burs 2; a root-fragment remover 5 may be configured to extract the first tooth fragment 40 and stabilize the second tooth fragment 400 (FIGS. 7A, 7B); a split end elevator 6 having a v-shaped notch tip 60 may be configured to remove the first tooth fragment 40 (FIGS. 8A, 8B); a cylindrical bur 7 to control the thickness of the second root fragment 400 (FIGS. 9A, 9B); and a round bur 8 may be configured to separate the second root fragment 400 from unwanted fragments (FIGS. 10A, 10B).

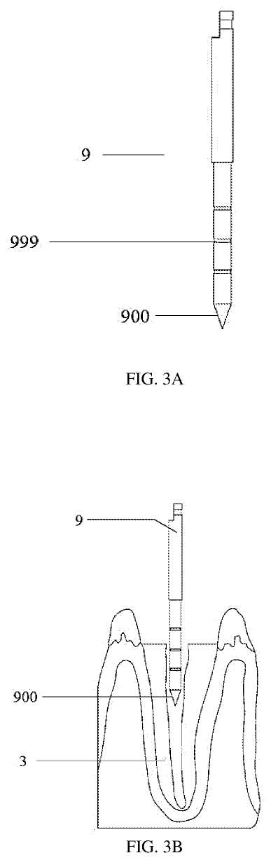

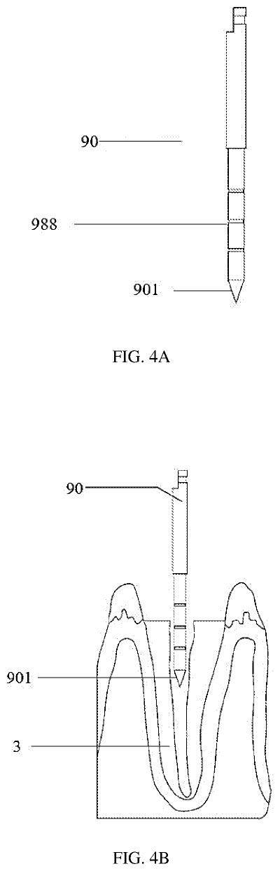

In some embodiments, the socket shield technique kit may further include a first drill 9 and a second drill 90 (FIGS. 3A-4B).

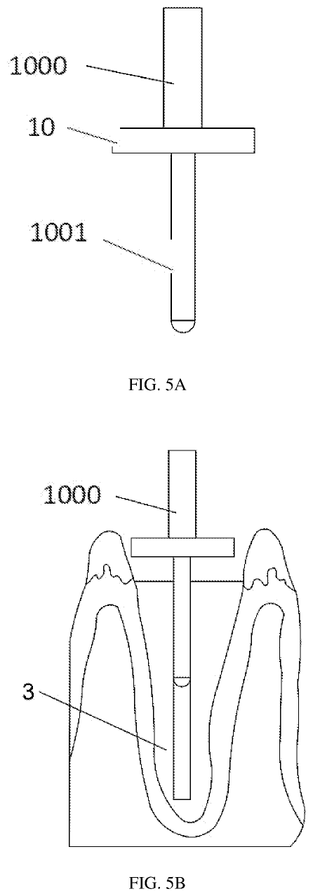

In some embodiments of the present disclosure, the kit may further include a diameter gauge 10 (FIGS. 5A, 5B).

The first drill 9 and the second drill 90 may have a first rotating drill-bit 900 and a second rotating drill bit that may be configured to create a hole in the root canal 3 when rotating.

The first drill 9 and the second drill 90 may be configured to widen the root canal 3 to receive the diameter gauge 10.

The first drill 9 and the second drill 90 may have different sizes, wherein each the first drill 9 and the second drill 90 may have calibration marks 999, 988 to indicate the depth of the drilling.

In embodiments of the present disclosure, the first working surface disc 110 of the wheel bur 1 may be a coarse surface working disc, and the second working surface disc 120 of the wheel bur 1 may be a fine surface working disc.

The first coarse working surface disc 110 of the wheel bur 1 may be configured to cut hard tissues of a tooth 100, while the second fine working surface disc 120 of the wheel bur 1 may be configured to smoothen the surface of the tooth 100.

The wheel bur 1 may be compatible with a slow speed and high-speed hand piece.

The diameter gauge 10 may be a round disc with a first vertical bar 1000, and a second vertical bar 1001, each positioned in the center of the round disc, and may be configured to identify the dimensions of the root canal 3, wherein the first bar 1000 and the second bar 1001 may have different sizes, such that the first vertical bar is compatible with the first drill 9 and the second vertical bar 1001 is compatible with the second drill 90.

The one or more trephine burs 2 may have different sizes, and may be configured to receive the diameter gauge 10 to guide cutting the root canal 3.

The diameter gauge 10 may be configured to determine the size of the one or more trephine burs 2 needed to cut the remaining root.

The diameter gauge 10 may be configured to be incorporated within the one or more trephine burs 2 to stabilize the path of cutting the root canal 3, thus preventing the one or more trephine burs 2 from deviation in any angle while cutting.

Trephining the root canal by the one or more trephine burs 2 may create the first tooth fragment 40 and the second tooth fragment 400 on the perimeter of the root canal 3 (represented as two sides in FIG. 7B).

In embodiments of the present disclosure, the one or more trephine burs 2 may have calibration marks 999, 988 to indicate a reached depth while trephining the root canal.

The stoppers 22 may be configured to prevent the one or more trephine burs 2 from slipping on an occlusal surface of the root while trephining.

The root fragment remover 5 may be a cylindrical hollow housing 501 having an upper end 502, a lower end 503, a wall 504, a first lateral cut 505, and a second lateral cut 506. The wall 504 may have a portion 507 between the first lateral cut 505 and the second lateral cut 506 that may act as a gripper. The portion 507 may move relatively to the wall 504 when a lateral force applied thereon, thus enabling the extraction of the first tooth fragment 40.

The v-shaped notch tip 60 of the split end elevator 6 may enable removing the first root fragment 40 without causing any damage to the alveolar bone.

The v-shaped notch tip 60 of the split end elevator removes the first root fragment 40 by a twist move.

Removing the first root fragment 40 may be done by positioning the first root fragment 40 in-between the split end elevator's v-shaped notch tip 60.

In embodiments of the present disclosure, the cylindrical bur 7 may have a shank 70 and a rotating head 700, wherein such cylindrical bur may be configured to control the thickness of the second tooth fragment 400.

Similarly, the round bur 8 may have a shank 80 and a rotating head 800, and may be configured to have a built-in stopper 22.

The round bur 8 may separate unwanted fragments from the second tooth fragment 400.

Reference is now being made to FIG. 13, with continued reference to FIGS. 1A-10B. Embodiments of the disclosure further provide a method for performing socket shield technique using the manual kit of the present disclosure, wherein the method may include the steps of:
Smoothening a surface of the tooth using the first working surface disc 110 and the second working surface disc 120 of the wheel bur 1 (process block 13-1);
Drilling the root canal 3 of the tooth using the first drill 9 and the second drill 90 depending on the root canal 3 size, wherein the first drill 9 and the second drill 90 have different sizes (process block 13-2);
Measuring the dimensions of the root canal 3 using the diameter gauge 10 (process block 13-3);
Determining the dimensions of the other working parts within the dimensions of the root canal 3 using the diameter gauge 10 (process block 13-4);
Cutting down the root canal 3 using the one or more trephine burs 2 guided by the diameter gauge 10, wherein the diameter gauge 10 is incorporated within the one or more trephine burs 2 to determine and stabilize the path of the drilling, thus preventing the one or more trephine burs 2 from deviation while cutting, (process block 13-5);
Creating the first tooth fragment 40 and the second tooth fragment 400 on each side of the root canal 3 (process block 13-6);
Extracting the first tooth fragment 40 using the root fragment remover 5, wherein a force is applied on the portion 507 to stabilize the second tooth fragment 400 and break the first tooth fragment 40 (process block 13-7);
Removing the first tooth fragment 40 using the split-end elevator 6 (process block 13-8);
Smoothing and controlling the thickness of the second root fragment 400 using the cylindrical bur 7 (process block 13-9); and
Separating unwanted fragments from the second tooth fragment 400 using the round bur 8 (process block 13-10).

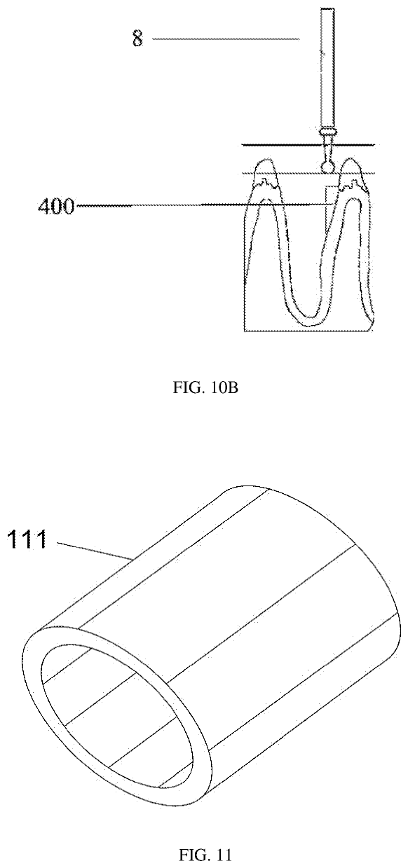

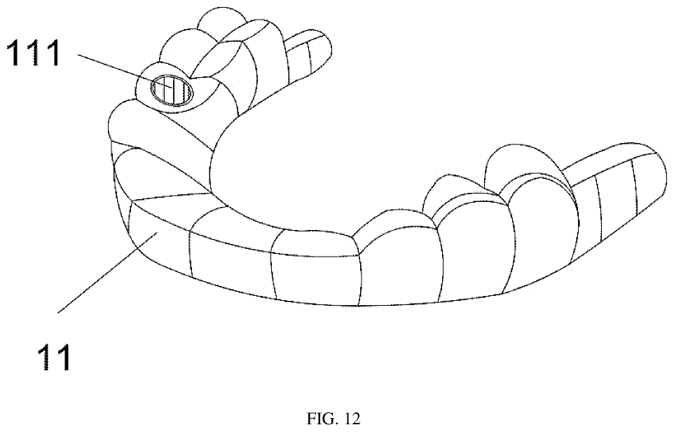

Reference is now being made to FIGS. 1A-13. In other embodiments of the present disclosure, the socket shield technique kit may further comprise a computer designed surgical guide template 11 and sleeves 111 that may be configured to guide the one or more trephine burs 2.

In embodiments of the present disclosure, the sleeves 111 may be configured to be incorporated within the computer designed surgical guide template 11 and may be compatible with each of the one or more trephine burs 2 size.

In embodiments of the present disclosure, the sleeves 111 may be made of metal, and may have a ring shape.

In embodiments of the present disclosure, the computer designed surgical guide template 11 may be configured to fit onto the surface of one or more teeth.

In embodiments of the present disclosure, the one or more trephine burs 2 may be positioned inside the sleeves 111 to guide the trajectory of trephining.

Reference is now being made to FIG. 14 with continued reference to FIGS. 1A-2B, 6A, and 7A-12. Embodiments of the present disclosure further provide method for performing socket shield technique using the kit of the disclosure, wherein the method may include the steps of:
Taking a Cone Beam Computed Tomography (CBCT) to a site requiring socket shield technique implant, thus determining the dimensions of the root canal 3 (process block 14-1);
Taking a 3D scan of the teeth to produce a 3D print-out of the teeth (process block 14-2);
Fabricating the computer designed surgical guide template 11 based on the dimensions obtained from the CBCT and the 3D scan, wherein designing the surgical guide template 11 is by using a dental software to determine and locate directions of drilling (process block 14-3);
Smoothening the surface of the tooth using the first working surface disc 110 and the second working surface disc 120 of the wheel bur 1 (process block 14-4);
Cutting down the root canal 3 using the one or more trephine burs 2 (process block 14-5);
Creating the first tooth fragment 40 and the second tooth fragment 400 on each side of the root canal 3 (process block 14-6);
Extracting the first tooth fragment 40 using the root fragment remover 5, wherein a force is applied on the portion 507 to stabilize the second tooth fragment 400 and break the first tooth fragment 40 (process block 14-7);
Removing the first tooth fragment 40 using the split-end elevator 6 (process block 14-8);
Smoothing and controlling the thickness of the second root fragment 400 using the cylindrical bur 7 (process block 14-9); and
Separating unwanted fragments from the second tooth fragment 400 using the round bur 8 (process block 14-10).

While the present disclosure has been described in detail and with reference to specific embodiments, it will be apparent to those skilled in the art that various additions, omissions, and/or amendments can be made without departing from the scope and spirit thereof.

What is claimed is:

1. A kit for performing socket shield technique, the kit comprises:
A wheel bur, having a first working surface disc configured to cut hard tissues of a tooth and a second working surface disc configured to smoothen a surface of the tooth; one or more trephine burs with stoppers configured to cut a root canal to create a first tooth fragment and a second tooth fragment, wherein each stopper is compatible with each of the one or more trephine burs; a root fragment remover configured to extract the first tooth fragment and stabilize the second tooth fragment; a split end elevator having a v-shaped notch tip configured to remove the first tooth fragment; a cylindrical bur to control the thickness of the second root fragment; and a round bur configured to separate the second root fragment from unwanted fragments.

2. The kit of claim 1, further comprising a first drill and a second drill.

3. The kit of claim 1, further comprising a diameter gauge.

4. The kit of claim 1, further comprising a computer designed surgical guide template and one or more sleeves configured to guide the one or more trephine burs.

5. The kit of claim 2, wherein the first drill and the second drill have a first rotating drill bit and a second rotating drill bit configured to create a hole in a root canal when rotating.

6. The kit of claim 3 or 5, wherein the first drill and the second drill are configured to widen the root canal to receive the diameter gauge.

7. The kit of claim 2, wherein the first drill and the second drill have different sizes.

8. The kit of claim 2, wherein the first drill and the second drill have calibration marks indicate the depth of the drilling.

9. The kit of claim 1, wherein the first working surface disc of the wheel bur is a coarse surface working disc.

10. The kit of claim 1, wherein the second working surface disc of the wheel bur is a fine surface working disc.

11. The kit of claim 9, wherein the first coarse working surface disc of the wheel bur is configured to cut hard tissues of a tooth.

12. The kit of claim 10, wherein the second fine working surface disc of the wheel bur is configured to smoothen the surface of the tooth.

13. The kit of claim 3, wherein the diameter gauge is a round disc with a vertical bar positioned in a center of the round disc.

14. The kit of claim 1, wherein the one or more trephine burs have different sizes.

15. The kit of claim 1 or 3, wherein the diameter gauge is configured to identify the dimensions of the root canal.

16. The kit of claim 1 or 3, wherein the diameter gauge is configured to determine the size of the one or more trephine burs to cut the remaining root.

17. The kit of claim 1 or 3, wherein the trephine bur is configured to receive the diameter gauge to guide cutting the root canal.

18. The kit of claim 1 or 3, wherein the diameter gauge is configured to be incorporated within the one or more trephine burs to stabilize the path of cutting the root canal, thus preventing the one or more trephine burs from deviation while cutting.

19. The kit of claim 1, wherein trephining the root canal by the one or more trephine burs creates the first tooth fragment and the second tooth fragment.

20. The kit of claim 1, wherein the one or more trephine burs have calibration marks to indicate a reached depth while trephining the root canal.

21. The kit of claim 1, wherein the stoppers are configured to prevent the one or more trephine burs from slipping on an occlusal surface of the root while trephining.

22. The kit of claim 1 or 4, wherein the one or more sleeves are configured to be incorporated within the computer designed surgical guide template and are compatible with each of the one ore trephine burs size.

23. The kit of claim 4, wherein the one or more sleeves are made of metal.

24. The kit of claim 4, wherein the one or more sleeves have a ring shape.

25. The kit of claim 4, wherein the one or more trephine burs are positioned inside the one or more sleeves to guide the trajectory of trephining.

26. The kit of claim 1, wherein the root fragment remover is a cylindrical hollow housing having an upper end, a lower end, a wall, a first lateral cut, and a second lateral cut.

27. The kit of claim 26, wherein the wall has a portion between the first lateral cut and the second lateral cut configured to act as a gripper.

28. The kit of claim 1 or 26, wherein the portion moves relatively to the wall when a lateral force applied thereon, thus enabling the extraction of the first tooth fragment.

29. The kit of claim 1, wherein the v-shaped notch tip of the split end elevator enables removing the first root fragment without causing any damage to the alveolar bone.

30. The kit of claim 1, wherein the v-shaped notch tip of the split end elevator removes the first root fragment by a twist move.

31. The kit of claim 1, wherein the removing the first root fragment is by positioning the first root fragment in-between the split end elevator's v-shaped notch tip.

32. The kit of claim 1, wherein the cylindrical bur has a shank and a rotating head.

33. The kit of claim 1, wherein the cylindrical bur controls the thickness of the second tooth fragment.

34. The kit of claim 1, wherein the round bur has a shank and a rotating head.

35. The kit of claim 1, wherein the round bur is configured to have a built-in stopper.

36. The kit of claim 1, wherein the round bur separates unwanted fragments from the second tooth fragment.
